(19) United States
(12) Patent Application Publication
(10) Pub. No.: US 2026/0368094 A1
(43) Pub. Date: Nov. 19, 2026

(54) PREDICTION METADATA STORAGE

(71) Applicant: Arm Limited, Cambridge (GB)

(72) Inventors: Ugo CASTORINA, Biot (FR); Jérémy SAUGET, Antibes (FR); Geoffray Matthieu LACOURBA, Nice (FR); Damien Matthieu Valentin CATHRINE, Mougins (FR)

(21) Appl. No.: 19/202,337

(22) Filed: May 8, 2025

(51) Int. Cl. G06F 12/084; G06F 9/38; G06F 12/0862; G06F 12/0864

(52) U.S. Cl. CPC G06F 12/084; G06F 9/3844; G06F 12/0862; G06F 12/0864

(57) ABSTRACT

An apparatus comprises prediction circuitry configured to provide data processing predictions to control speculation of data processing operations by data processing circuitry. Shared storage circuitry is provided comprising a plurality of entries each configured to store one of: prediction metadata associated with the prediction circuitry, and further data associated with at least one further transaction source, where the shared storage circuitry is configured to prioritise storage of the prediction metadata over storage of the further data for a number of entries of the shared storage circuitry selected in dependence on a metadata partition size. Storage configuration circuitry is configured to dynamically select the metadata partition size in dependence on a prediction metadata usefulness metric.

### BACKGROUND

### Technical Field

The present technique relates to the field of data processing.

### Technical Background

A data processing apparatus may provide prediction circuitry to make predictions in respect of data processing operations. Such predictions are not particularly limited, and may for example include predicting the outcome of control flow instructions such as branch instructions, predicting which addresses will be accessed by future memory access instructions, predicting data values output by data processing instructions, and so on.

Providing prediction circuitry can allow a data processing apparatus to speculatively perform certain operations which depend on the outcome of a particular operation, using the predicted outcome of that operation, before the actual outcome is known. For example, the data processing apparatus may speculatively fetch data based on a prediction that the data will be required by a future memory access instruction, before that memory access instruction is executed, and in so doing can reduce the time taken to access that data when it is required.

Providing prediction circuitry can therefore allow performance of a data processing apparatus to be improved.

### SUMMARY

At least some examples of the present technique provide an apparatus, comprising:
prediction circuitry configured to provide data processing predictions to control speculation of data processing operations by data processing circuitry;
shared storage circuitry comprising a plurality of entries each configured to store one of: prediction metadata associated with the prediction circuitry, and further data associated with at least one further transaction source,
wherein the shared storage circuitry is configured to prioritise storage of the prediction metadata over storage of the further data for a number of entries of the shared storage circuitry selected in dependence on a metadata partition size; and
storage configuration circuitry configured to dynamically select the metadata partition size in dependence on a prediction metadata usefulness metric.

At least some examples provide a method, comprising:
providing data processing predictions to control speculation of data processing operations by data processing circuitry;
storing any one of: prediction metadata and further data associated with at least one further transaction source in a plurality of entries of shared storage circuitry;
prioritising storage of the prediction metadata over storage of the further data for a number of entries of the shared storage circuitry selected in dependence on a metadata partition size; and
dynamically selecting the metadata partition size in dependence on a prediction metadata usefulness metric.

At least some examples provide computer-readable code for fabrication of an apparatus, comprising:
prediction circuitry configured to provide data processing predictions to control speculation of data processing operations by data processing circuitry;
shared storage circuitry comprising a plurality of entries each configured to store one of: prediction metadata associated with the prediction circuitry, and further data associated with at least one further transaction source,
wherein the shared storage circuitry is configured to prioritise storage of the prediction metadata over storage of the further data for a number of entries of the shared storage circuitry selected in dependence on a metadata partition size; and
storage configuration circuitry configured to dynamically select the metadata partition size in dependence on a prediction metadata usefulness metric.

The computer-readable code may be stored on a computer-readable storage medium. The computer-readable storage medium may be non-transitory.

Further aspects, features and advantages of the present technique will be apparent from the following description of examples, which is to be read in conjunction with the accompanying drawings.

### BRIEF DESCRIPTION OF THE DRAWINGS

FIG. 1 illustrates an example of a data processing apparatus;

FIG. 2 schematically illustrates an example configuration of a set-associative cache;

FIG. 3 illustrates an entry of a shared cache;

FIG. 4 is a flow diagram illustrating a method of allocating entries into a shared cache in accordance with a metadata partition size;

FIG. 5 illustrates an approach for determining metadata occupancy within a cache;

FIG. 6 illustrates an approach for determining values contributing to a potential relative coverage for a data prefetcher;

FIG. 7 is a flow diagram illustrating a method for updating a metadata partition size based on a prediction metadata usefulness metric;

FIGS. 8A and 8B illustrate matrices for updating a metadata partition size based on two values contributing to a prediction metadata usefulness metric;

FIG. 9 is a flow diagram illustrating a method according to the present techniques; and

FIG. 10 illustrates a system and a chip-containing product.

### DESCRIPTION OF EXAMPLES

As discussed above, a data processing apparatus may comprise prediction circuitry configured to provide data processing predictions to control speculation of data processing operations which may be performed by data processing circuitry. Such data processing predictions may include predicted outcomes of control flow instructions, addresses predicted to be accessed by future memory access instructions, predicted data value outcomes of data processing instructions, and so on.

The prediction circuitry may generate data processing predictions based on data determined through training. For instance, by observing a training stream including data processing operations performed by the data processing apparatus, the prediction circuitry may identify relationships between data processing operations which may be used to make data processing predictions. For example, in the context of prefetching, a stride relationship may be identified between a first address accessed in response to a first memory access instruction and a subsequent address of a subsequent memory access instruction, and observation of the first address may be used to predict that the subsequent address will be subsequently accessed. In a different example, a producer-consumer relationship could be identified between data (e.g., a pointer) accessed in response to a first memory access instruction and a subsequent address of a subsequent memory access instruction, and the subsequent address may be predicted based on observing a memory access instruction accessing the data.

In the course of training the prediction circuitry and generating data processing predictions, the prediction circuitry may generate prediction metadata. The prediction metadata may for example include training data generated by the prediction circuitry representing observed relationships profiling the input stream, and may include further data such as values for controllable parameters of the prediction circuitry and so on.

One approach for storing the prediction metadata is to provide dedicated prediction metadata storage within the prediction circuitry which can only be used for the prediction metadata of that prediction circuitry. However, in other examples the data processing apparatus provides shared storage circuitry comprising a plurality of entries each configured to store one of: the prediction metadata associated with the prediction circuitry, and further data associated with at least one further transaction source. The at least one further transaction source is not particularly limited, and may for example include another unit generating metadata, instruction fetch circuitry, data fetch circuitry, and so on as will be discussed in greater detail below. Storing (at least a subset of) the prediction metadata in the shared storage circuitry can be associated with area savings, as the provided storage can be used more efficiently (e.g., entries not used for the prediction metadata can be used to store other data).

However, storing the prediction metadata in the shared storage circuitry may be associated with the problem of pollution of the shared storage circuitry by prediction metadata if a large volume of prediction metadata is generated. This can increase contention for, and reduce availability of, entries in the shared storage circuitry available for the at least one further transaction source, which may negatively affect performance.

To reduce the risk of pollution, the shared storage circuitry may be partitioned. That is, the shared storage circuitry is configured to prioritise storage of the prediction metadata over storage of the further data for a number of entries of the shared storage circuitry selected in dependence on a metadata partition size, and for example prioritise storage of the further data over storage of the metadata for the remaining entries of the shared storage circuitry. In this way, when the number of entries storing prediction metadata is below the number of entries selected based on the metadata partition size, the shared storage circuitry may prioritise storage of prediction metadata to ensure that there will be some availability of the shared storage circuitry for prediction metadata, and when the number of entries storing prediction metadata is above the number of entries selected based on the metadata partition size, the shared storage circuitry may prioritise storage of the further data to ensure that the prediction metadata does not pollute the shared storage circuitry.

In a comparative example, the metadata partition size may be fixed, meaning that the shared storage circuitry may prioritise the storage of prediction metadata for a static number of entries. However, the inventors have realised that in several scenarios, such an approach may be associated with drawbacks. For instance, if the prediction circuitry is not particularly useful during a particular stage of processing (e.g., it has a low accuracy, or the number of potential predictions that can be made are limited fora particular workload) then a static metadata partition size may provide too much storage for the prediction metadata when that storage could have instead been used for the further transaction sources which might be able to more effectively use entries of the shared storage circuitry. Therefore, a fixed metadata partition size risks over-provisioning entries for the prediction metadata in scenarios where the prediction circuitry is less useful, and in so doing may reduce performance by unnecessarily reducing the number of entries available to the further transaction sources.

According to the present techniques, the storage configuration circuitry is configured to dynamically select the metadata partition size in dependence on a prediction metadata usefulness metric. The prediction metadata usefulness metric will be discussed in greater detail below, but in general may indicate a current usefulness of the prediction circuitry. When the prediction circuitry is more useful then it may be justified to provide a larger metadata partition size, which may allow the prediction circuitry to have access to more prediction metadata (e.g., training data) which may improve performance of the prediction circuitry, and if the prediction circuitry is currently useful, this may improve overall performance of the data processing apparatus. When the prediction circuitry is less useful, then it may not be justified to provide a larger metadata partition size, as the larger amount of prediction metadata may not translate into improved overall performance and may come at the expense of overall performance which could have otherwise been provided by the further transaction sources using the entries of the shared storage circuitry. Therefore when the prediction circuitry is less useful the metadata partition size might be decreased.

As mentioned, the shared storage circuitry is not particularly limited. In some examples, the shared storage circuitry may comprise storage circuitry shared between different microarchitectural units storing their metadata in the shared storage circuitry, and by varying the metadata partition size for the prediction circuitry this can allow the other units to store more metadata (and therefore potentially improve overall performance) when the prediction circuitry is less useful.

In some examples, the shared storage circuitry may comprise a shared cache within a memory system accessed by the data processing circuitry. The data processing circuitry may have access to a memory system including a main memory and one or more levels of cache to temporarily store data stored in the main memory, to allow that data to be accessed more quickly by the data processing circuitry. At least one cache may provide the shared storage circuitry. The further data stored in the shared cache (e.g., a L2 cache) may include, for example, cached instructions (for which the associated transaction source may be instruction fetch circuitry), cached data (for which the associated transaction source may be load/store circuitry), and/or cached address translation information (for which the associated transaction source may be a memory management unit (MMU) of the data processing apparatus). Within a shared cache, dynamically varying the size of the metadata partition size can be associated with various performance improvements. For instance, when the prediction circuitry is less useful then reducing the metadata partition size can make more entries available for caching instructions, data, and/or address translation information, which can improve performance of the data processing apparatus by reducing a time taken to fetch instructions and/or data. However, when the prediction circuitry is more useful then the increased metadata partition size can allow the prediction circuitry to have access to more training data and provide more useful predictions, the performance improvements of which can outweigh an increased instruction/data fetch latency caused by reducing a number of entries available for cached instructions, data and/or address translation data.

In some examples, the storage configuration circuitry may be configured to select the metadata partition size to be greater than zero. This means that there will be at least one entry of the shared storage circuitry which prioritises storage of the prediction metadata, allowing the prediction circuitry to store at least some prediction metadata. If the metadata partition size were instead reduced to zero when entering a workload where its predictions are less useful, then the prediction circuitry might not have an opportunity to train (it may essentially be turned off) and therefore it might be difficult to gauge how useful the prediction circuitry at some future point. By providing at least some storage in the shared storage circuitry for prediction metadata, then the prediction circuitry is able to continue some degree of training such that the prediction metadata usefulness metric may more accurately represent an actual usefulness of the prediction circuitry, giving the prediction circuitry an opportunity to show when it is becoming more useful again as the workload changes to one where the predictions might be more useful.

In some examples, the storage configuration circuitry may be configured to select the metadata partition size to be lower than a total number of entries of the shared cache. Therefore, there can be at least one entry available for the at least one further transaction source. This can avoid the prediction circuitry from completely blocking the at least one further transaction source from use of the shared storage structure even when the prediction circuitry is particularly useful. This can improve performance overall, as the cost of entirely blocking a transaction source from using the shared storage circuitry (e.g., entirely preventing an MMU from caching address translation data) might outweigh the marginal increase in prediction performance which could be achieved by providing more prediction metadata storage. In some examples, the storage configuration circuitry may be configured to select the metadata partition size to provide at least one entry available for each of the at least one further transaction sources.

In some examples, the shared storage circuitry may have a set-associative structure. The shared storage circuitry may comprise a plurality of sets, each set containing a plurality of entries (or ways). Data associated with a particular address may only be stored within a particular set, but may be stored in any entry of that set. The metadata partition size may indicates a number of entries per set for which the shared storage circuitry is configured to prioritise storage of the prediction metadata over storage of the further data. For example, if each set of the shared storage circuitry contains N entries then the metadata partition size may indicate how many of those N entries should prioritise storage of the prediction metadata. The metadata partition size may therefore be enforced on a per-set basis, rather than based on an overall number of entries in the shared storage circuitry. As data associated with a particular address can only be stored in a particular set, enforcing the metadata partition size for each set means that the prediction metadata cannot pollute any particular set (even if the total number of prediction metadata entries in the storage circuitry is low) preventing use of that set for the further data, and vice versa.

In some examples, the storage configuration circuitry may be configured to determine the prediction metadata usefulness metric based on a potential coverage estimate of the prediction circuitry. The potential coverage estimate may represent a potential performance improvement associated with use of the prediction circuitry, and therefore by basing the prediction metadata usefulness metric on the potential coverage estimate, the metadata partition size may be selected based how much performance may be improved by use of the prediction circuitry.

In some examples, the potential coverage estimate may be based on an proportion of data processing operations for which the prediction circuitry is estimated to be capable of providing a data processing prediction. Prediction circuitry may be capable of providing predictions for a certain subset of data processing operations in a particular workload, and the size of the subset may vary between different workloads. The potential coverage of the prediction circuitry may vary between workloads for many reasons, including the type of operations used in different workloads, the regularity of operations in different workloads, and so on. The potential coverage may represent how many operations can possibly be predicted by the prediction circuitry, and may represent an upper bound on the actual coverage of the prediction circuitry, which may vary depending on the training data accessible to the prediction circuitry (which may vary, for example, based on the metadata partition size). When the potential coverage is higher, then more operations may be predicted using the prediction circuitry and this can justify a larger metadata partition size to allow the actual coverage to be increased towards the potential coverage. When the potential coverage is lower, then increasing the metadata partition size may not significantly increase the actual coverage and therefore a smaller metadata partition size may be used.

In some examples, the prediction circuitry may comprise prefetch circuitry for prefetching data into a cache. The cache may be a shared cache (e.g., storing the prediction metadata) or a further cache. The prefetch circuitry may predict a future memory access instruction for accessing target data in memory, and the prefetch circuitry may seek to fetch the target data into the cache in advance of the future memory access instruction being executed, so that the delay for accessing the target data is lower when the future memory access instruction is executed. For prefetch circuitry, the potential coverage may represent the number of memory access instructions which can be predicted and have their data prefetched into the cache. When the prediction circuitry comprises prefetch circuitry, the potential coverage estimate may be based on a number of access requests forming part of an input stream to the prefetch circuitry. The input stream may include the memory access instructions on which the prefetch circuitry is trained, and may for example represent the maximum number of memory access instructions which could theoretically be predicted by the prefetch circuitry. The prefetch circuitry may not be able to make predictions in respect of instructions which are not part of the input stream.

Different examples of prefetch circuitry may select the input stream in various ways. In some examples, an access request may form part of the input stream when the access request is of a relevant type and either: misses in the cache, or hits against an entry previously prefetched into the cache by a relevant prefetch mechanism. The relevant type might include the types of access request which can be predicted by the prefetch circuitry. For example, fora data prefetcher the relevant type may comprise load instructions and store instructions, for an MMU prefetcher the relevant type might include page table accesses, for an instruction prefetcher the relevant type might include instruction fetches. The input stream includes access requests which might be usefully prefetched by the prefetch circuitry, and therefore may include access requests which previously missed in the cache, as those access requests are likely to benefit from prefetching as the requested data for those requests may be less likely to already be in the cache. The input stream may also include access requests which hit against previously prefetched entries. If the only reason that an access request hit in the cache was due to previous prefetching, then excluding that access request from the input stream might risk the access request not being prefetched in future and therefore missing in the cache, and therefore previously prefetched entries may be include in the input training stream. The relevant prefetch mechanism (which fetched those previously prefetched entries) may not include all prefetch mechanisms, but may include the prefetch circuitry being trained, as well as any other prefetch mechanism which allows training of the prefetch circuitry. For example, even if the prefetch circuitry was not the prefetch mechanism which previously prefetched the entry requested by an access request, the access request may be included in the input stream if the other prefetch mechanism is of a type which allows training of the prefetch circuitry (e.g., the prefetch circuitry and the other prefetch mechanism may both be capable of predicting the access request and therefore it may be included in input streams for both mechanisms). Access requests which hit in the cache against an entry previously fetched by a demand (e.g., a load/store rather than a prefetch) might be excluded from the input stream, as these may not benefit from prefetching.

In addition to the number of predictable access requests, the potential coverage estimate may also be based on a total number of relevant accesses to the cache. The total number of relevant accesses may contextualise the number of accesses in the input stream. For example, the potential coverage may be expressed (i.e., as a potential relative coverage) as a fraction of the number of access requests in the input stream compared to the total number of relevant access requests to the cache. If the input stream only represents a small proportion of total relevant accesses to the cache then the potential benefit of the prediction circuitry may be lower, and if the input stream represents a larger proportion of the total relevant accesses to the cache then the benefit of the prediction circuitry may be higher (and hence the metadata partition size may be adjusted as appropriate). The total number of relevant accesses to the cache could include all access requests to the cache, or may include a subset of these requests. For example, the total number of relevant accesses may exclude prefetch access requests triggered by the prefetch circuitry (as including these in the total number of accesses may artificially lower the relative coverage of the prefetcher). In some examples, the relevant accesses may include the accesses forming the input stream in addition to access requests not of the relevant type (e.g., for a data prefetcher, this may include MMU and instruction accesses) so that the total number represents the whole activity of the cache.

In some examples, the storage configuration circuitry may be configured to determine the prediction metadata usefulness metric based on a metadata occupancy value representing a number of entries in the shared storage circuitry identified as storing prediction metadata. For example, entries in the shared storage structure may provide a metadata flag indicating whether they store the prediction metadata or the further data, and the metadata occupancy value may represent a proportion of entries with the metadata flag set. The metadata occupancy value can be expressed in various ways, for example as a proportion of the maximum metadata partition size. By including the metadata occupancy value in the determination of the prediction metadata usefulness metric, the metadata partition size can be adjusted based on an actual number of entries currently used for prediction metadata. For example, if a lower number of entries are actually being used for prediction metadata then it may be less important to reduce the metadata partition size. However, if it is observed that a large number of entries are being used to store prediction metadata then it may be beneficial to reduce the metadata partition size to permit other transaction sources to have access to resource in the shared storage circuitry.

The number of entries in the shared storage circuitry identified as storing prediction metadata may include the total number of entries in the shared storage circuitry storing prediction metadata. However, in some examples, where the shared storage circuitry has a set-associative structure, the storage configuration circuitry may be configured to determine the metadata occupancy value based on a number of entries storing prediction metadata in one or more accessed sets of the shared storage circuitry. For example, sets may be accessed when data is being allocated into the shared storage circuitry. The metadata occupancy value may represent how many entries store prediction metadata in those sets actually accessed during a workload (and this may be referred to as a biased occupancy). This may provide a more useful occupancy metric as it represents the metadata occupancy from the perspective of a program using the shared storage structure, and may not include the occupancy of sets which are irrelevant to a current workload.

It will be appreciated that both the potential coverage and the metadata occupancy may contribute to the prediction metadata usefulness metric, which may compare how useful the prediction metadata is for performance against how much of the shared storage circuitry is being occupied by the prediction metadata to control the metadata partition size. For example, the prediction metadata usefulness metric may be calculated as the potential coverage divided by the metadata occupancy.

The storage configuration circuitry may be configured to dynamically select the metadata partition size in dependence on a prediction metadata usefulness metric in various ways. In some examples, the storage configuration circuitry may be configured to increment or decrement the metadata partition size (within limits defining minimum and maximum metadata partition sizes) in dependence on the prediction metadata usefulness metric. For example, the prediction metadata usefulness metric may be compared against a threshold, and if the prediction metadata usefulness metric exceeds the threshold then the metadata partition size may be increased and if the prediction metadata usefulness metric does not exceed the threshold then the metadata partition size may be decreased. The metadata partition size updates may be carried out periodically (e.g., after a certain number of access requests to a cache). Incrementally changing the metadata partition size over time may make the metadata partition size less susceptible to sudden changes in workload, and can allow the changes caused by each change to be assessed before deciding whether to further change the metadata partition size. In one particular example, the threshold could be one. When the prediction metadata usefulness metric comprises a fraction of the potential coverage and the metadata occupancy, then a threshold of one means that the comparison is essentially a direct comparison between the potential coverage and the metadata occupancy to determine whether to increase or decrease the metadata partition size. If the potential coverage (e.g., the dimensionless quantity representing the relative potential coverage as a proportion of total requests to a cache) is larger than the metadata occupancy (e.g., the dimensionless quantity representing a proportion of a maximum partition size occupied by metadata entries) then the metadata partition size may be increased, and vice versa.

In some examples, the prediction metadata usefulness metric may comprise N elements (e.g., potential coverage and metadata occupancy when N=2). Each of the N elements may be associated with a score, and an entry of an N-dimensional matrix may be accessed using the scores. The accessed entry may indicate whether to increment or decrement the metadata partition size.

In some examples, rather than marginally changing the metadata partition size each time at each metadata partition size update, the storage configuration circuitry may be configured to select a precomputed metadata partition size in dependence on the prediction metadata usefulness metric. This may allow the metadata partition size to be more responsive to changes in the workload. The precomputed metadata partition size could be selected in various ways. For example, a matrix approach as described above could be used, where the accessed entry of the N-dimensional matrix indicates the new metadata partition size.

As discussed above, the shared storage circuitry is configured to prioritise storage of the prediction metadata over storage of the further data for a number of entries of the shared storage circuitry selected in dependence on a metadata partition size. This could be implemented in various ways. In one example, when allocating a new entry in an accessed region (e.g., a particular set) of the shared storage circuitry, if there are any invalid entries, then the shared storage circuitry may allocate the new entry in the invalid entry. If there are no invalid entries, the shared storage circuitry may be responsive to a number of entries of in the accessed region storing the prediction metadata being greater than the metadata partition size to favour eviction of an entry storing the prediction metadata over an entry storing the further data, and the shared storage circuitry may be responsive to a number of entries of in the accessed region storing prediction metadata being less than the metadata partition size to favour eviction of an entry storing the further data over an entry storing the prediction metadata. If the number of metadata entries is equal to the metadata partition size, then the shared storage circuitry may evict an entry having the same type as the new entry (e.g., when allocating a metadata entry in a set containing the same number of entries as the metadata partition size, evict a previous metadata entry, and when allocating a further data entry, evict a previous further data entry).

It will be appreciated that the number of metadata entries in the shared storage circuitry is permitted to exceed the metadata partition size (e.g., if there are very few entries allocated by the further transaction sources then the shared storage circuitry may include invalid entries which can be used for prediction metadata). It will also be appreciated that the number of entries storing prediction metadata can be below the metadata partition size. The metadata partition size merely ensures that there will be at least a number of entries defined by the metadata partition size available for the prediction metadata if required, and the remaining number of entries will be available for the at least one further transaction source if required. It will be appreciated that the number of entries storing prediction metadata in the shared storage circuitry is relevant, but not which entries they are (i.e., specific entries do not need to be reserved for prediction metadata).

As mentioned above, in some examples the prediction circuitry may comprise prefetch circuitry. In such examples, the prediction metadata may comprise information representing relations which enable later memory accesses to be predicted based on earlier memory accesses.

Particular examples will now be described with reference to the Figures.

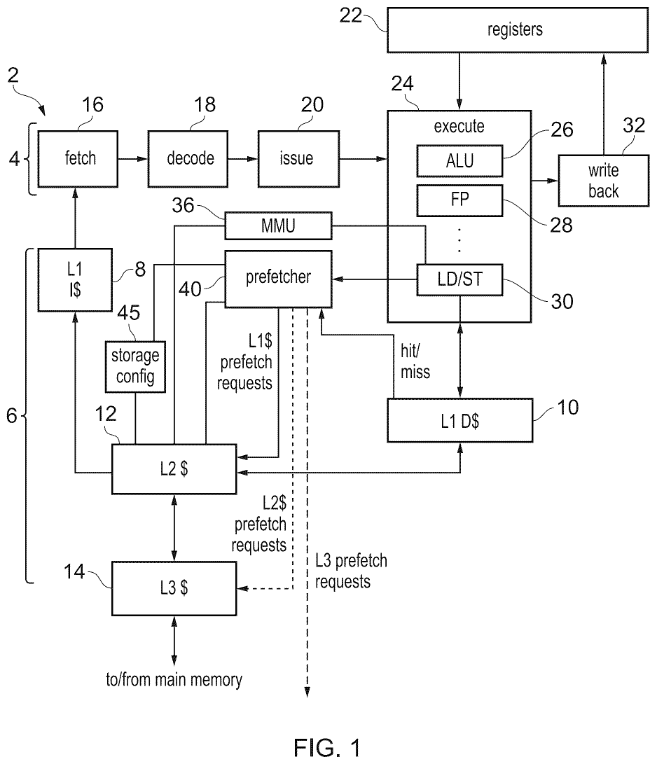

FIG. 1 illustrates an example of a data processing apparatus 2. The apparatus has a processing pipeline 4 for processing program instructions fetched from a memory system 6. The memory system in this example includes a level 1 instruction cache 8, a level 1 data cache 10, a level 2 cache 12 shared between instructions and data, a level 3 cache 14, and main memory which is not illustrated in FIG. 1 but may be accessed in response to requests issued by the processing pipeline 4. It will be appreciated that other examples could have a different arrangement of caches with different numbers of cache levels or with a different hierarchy regarding instruction caching and data caching (e.g. different numbers of levels of cache could be provided for the instruction caches compared to data caches).

The processing pipeline 4 includes a fetch stage 16 for fetching program instructions from the instruction cache 8 or other parts of the memory system 6. The fetched instructions are decoded by a decode stage 18 to identify the types of instructions represented and generate control signals for controlling downstream stages of the pipeline 4 to process the instructions according to the identified instruction types. The decode stage passes the decoded instructions to an issue stage 20 which checks whether any operands required for the instructions are available in registers 22 and issues an instruction for execution when its operands are available (or when it is detected that the operands will be available by the time they reach the execute stage 24). The execute stage 24 includes a number of functional units 26, 28, 30 for performing the processing operations associated with respective types of instructions. For example, in FIG. 1 the execute stage 24 is shown as including an arithmetic/logic unit (ALU) 26 for performing arithmetic operations such as add or multiply and logical operations such as AND, OR, NOT, etc. The execute unit also includes a floating point unit 28 for performing operations involving operands or results represented as a floating-point number. The functional units also include a load/store unit 30 for executing load instructions to load data from the memory system 6 to the registers 22 or store instructions to store data from the registers 22 to the memory system 6. Load requests issued by the load/store unit 30 in response to executed load instructions may be referred to as demand load requests. Store requests issued by the load/store unit 30 in response to executed store instructions may be referred to as demand store requests. The demand load requests and demand store requests may be collectively referred to as demand memory access requests. It will be appreciated that the functional units shown in FIG. 1 are just one example, and other examples could have additional types of functional units, or could have multiple functional units of the same type, or may not include all of the types shown in FIG. 1 (e.g. some processors may not have support for floating-point processing). The results of the executed instructions are written back to the registers 22 by a write back stage 32 of the processing pipeline 4.

A memory management unit (MMU) 36 controls address translations between virtual addresses specified by load/store requests from the load/store unit 28 and physical addresses identifying locations in the memory system, based on address mappings defined in a page table structure stored in the memory system. The page table structure may also define memory attributes which may specify access permissions for accessing the corresponding pages of the address space, e.g. specifying whether regions of the address space are read only or readable/writable, specifying which privilege levels are allowed to access the region, and/or specifying other properties which govern how the corresponding region of the address space can be accessed. Entries from the page table structure may be cached for speeding up access to page table entries from the page table structure in memory.

It will be appreciated that the pipeline architecture shown in FIG. 1 is just one example and other examples could have additional pipeline stages or a different arrangement of pipeline stages. For example, in an out-of-order processor a register rename stage may be provided for mapping architectural registers specified by program instructions to physical registers identifying the registers 22 provided in hardware. Also, it will be appreciated that FIG. 1 does not show all of the components of the data processing apparatus and that other components could also be provided.

For example, the apparatus 2 may also have a branch predictor to form predictions of branch behaviour of branch instructions so that the fetch stage 16 can fetch subsequent instructions beyond the branch earlier than if waiting for the actual branch outcome. The predictions provided by the branch predictor may be used by the fetch stage 6 to determine the sequence of addresses from which instructions are to be fetched from the instruction cache 8 or memory system. The branch predictor may include a number of different forms of prediction structures, including a branch target buffer (BTB) which may cache entries specifying predictions of whether certain blocks of addresses are predicted to include any branches, and if so, the instruction address offsets (relative to the start address of the block) and predicted target addresses of those branches. Also the branch predictor could include branch direction prediction structures which predict, if a given block of instruction addresses is predicted to include at least one branch, whether the at least one branch is predicted to be taken or not taken.

As shown in FIG. 1, the apparatus 2 has a prefetcher 40 for analyzing patterns of demand target addresses specified by demand memory access requests issued by the load/store unit 30, and detecting address access patterns which can subsequently be used to predict addresses of future memory accesses. For example, the address access patterns may involve stride sequences of addresses where there are a number of addresses separated at regular intervals of a constant stride value. It is also possible to detect other kinds of address access patterns (e.g. a pattern where subsequent accesses target addresses at certain offsets from a start address, or where subsequent target addresses are at certain offsets from data loaded by an earlier instruction). The prefetcher 40 maintains training data representing the observed address access patterns, and uses the training data to generate prefetch load requests which are issued to the memory system 6 to request that data is brought into a given level of cache. For example, when a trigger event for a given access pattern is detected (e.g., the trigger event could be program flow reaching a certain program counter address, or a load access to a particular trigger address being detected), the prefetcher 40 may begin issuing prefetch load requests for addresses determined according to that pattern. The prefetch load requests are not directly triggered by a particular instruction executed by the pipeline 4, but are issued speculatively with the aim of ensuring that when a subsequent load/store instruction reaches the execute stage 24, the data it requires may already be present within one of the caches, to speed up the processing of that load/store instruction and therefore reduce the likelihood that the pipeline has to be stalled.

The prefetcher 40 may be able to perform prefetching into a single cache or into multiple caches. For example, FIG. 1 shows an example of the prefetcher 40 issuing level 1 cache prefetch requests which are sent to the level 2 cache 12 or downstream memory and request that data from prefetch target addresses is brought into the level 1 data cache 10. Also the prefetcher in this example could also issue level 2 prefetch requests to the level 3 cache 14 or main memory requesting that data from prefetch target addresses is loaded into the level 2 cache 14, and/or level 3 prefetch requests to the main memory requesting that data from prefetch target addresses is loaded into the level 3 cache 14. The level 2 or level 3 prefetch requests may look a longer distance into the future than the level 1 prefetch requests to account for the greater latency expected in obtaining data from main memory into the level 2 or 3 cache 12, 14 compared to obtaining data from a level 2 cache into the level 1 cache 10. In systems using prefetching into multiple levels of cache, prefetches at level 2 or 3 can increase the likelihood that data requested by a level 1 prefetch request or demand access request is already in the level 2 or 3 cache. However, it will be appreciated that the particular caches loaded based on the prefetch requests may vary depending on the particular implementation.

As shown in FIG. 1, as well as the demand target addresses issued by the load/store unit 30, the training of the prefetcher 40 may also be based on an indication of whether the corresponding demand memory access requests hit or miss in the level 1 data cache 10. The hits/miss indication can be used for filtering the demand target addresses from training. This recognises that it is not useful to expend prefetch resource on addresses for which the demand target addresses would anyway hit in the cache. Performance improvement can be greater in focusing prefetcher training on those addresses which, in the absence of prefetching, would have encountered cache misses for the demand access requests. However, not all cache hit may be filtered out of the input stream, and hits on a line previously fetched into the cache by the prefetcher (or another prefetch mechanism) may remain in the input stream.

Whilst the prefetcher of FIG. 1 is shown to prefetch data into the L2 cache, an MMU prefetcher could also or alternatively be provided for prefetching page table data predicted to be accessed by the MMU 36, and/or an instruction prefetcher could be provided for prefetching instructions predicted to be fetched by the fetch circuitry 16.

The prefetcher 40 is an example of prediction circuitry which may generate prediction metadata. The prediction metadata may include training data derived from monitoring the input stream. The branch predictor is another example of prediction circuitry which may generate prediction metadata, which may include information for making branch direction and/or branch target predictions, such as the outcomes of previously observed branch instructions.

In the example of FIG. 1, the prefetcher 40 stores prediction metadata in the L2 cache 12. The prediction metadata may be stored in entries of the L2 cache which could alternatively be used to cache instructions (e.g., for access by the L1 I$8 or fetch circuitry 16), data (e.g., for access by the L1 D$10 or load/store unit 30), and/or page table data (e.g., for access by the MMU 36). The number of entries of the L2 cache which may be used to store prediction metadata may be restricted by defining a metadata partition size. When the number of entries storing prediction metadata (metadata entries) exceeds the metadata partition size then the L2 cache may prioritise evicting a metadata entry to make room for a new entry, and when the number of metadata entries is less than the metadata partition size then the L2 cache may prioritise evicting a non-metadata entry to make room for a new entry. This means that there will be some entries available for prediction metadata, but the prediction metadata is prevented from fully occupying the L2 cache and starving the other requesters (e.g., the fetch circuitry, load/store unit, and MMU) from having access to L2 cache resource.

The metadata partition size is dynamically adjustable based on a prediction metadata usefulness metric. This can allow the amount of space in the L2 cache permitted to be used for prediction metadata to vary depending on how useful the prediction circuitry is during a particular workload. Hence, when the prediction circuitry is less useful then more of the shared cache may be available for the other transaction sources, which can allow overall performance to be improved.

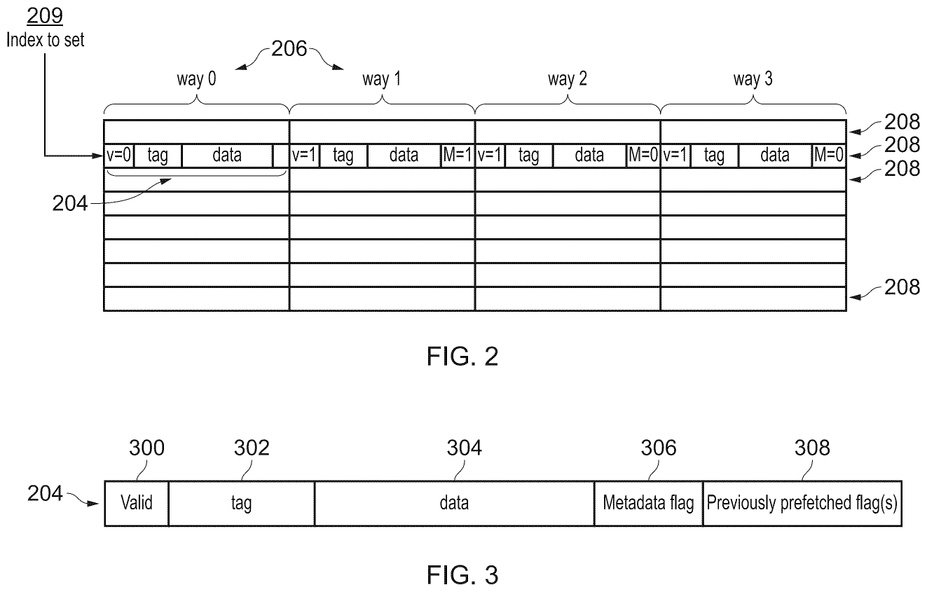

FIG. 2 schematically illustrates an example configuration of the shared (L2) cache shown in FIG. 1 which may store prediction metadata. The shared cache shown in FIG. 2 is a set-associative cache (although it will be appreciated that other cache structures, such as fully associative caches, are within the scope of the present technique).

As shown in FIG. 2, a set-associative cache comprises a number of sets 208 of cache entries 204, each set 208 having two or more entries 204. For a cache having associativity A, this means that the number of entries in one set 208 is A. Such a cache can be described as an “A-way”set-associative cache and the entries can also be considered to be logically grouped into “ways” 206, where each set 208 comprises one entry 204 from each way 206. For example, a cache with 4 entries per set is 4-way set-associative. It will be appreciated that FIG. 2 merely shows the logical arrangement of the entries 204, and the physical arrangement of the entries 204 may be different. For example, “neighbouring” entries of the same set 208 or the same way 204 may in practice be arranged at separate physical locations in a memory device.

The set-associative placement policy used for such a cache means that when data having a given address needs to be allocated into the cache, it is placed in one of the entries 204 within a particular set 208 that is selected based on an index value 209 computed based on the given address. In some cases the index value 209 may simply be a portion of bits extracted from the given address, while in other examples the index 209 could be based on a more complicated function of the given address (e.g. applying a hash function to the given address to obtain the index value 209). Hence, data associated with a given address cannot be stored in entries 204 of sets 208 other than the set corresponding to the index 209 selected based on the given address. This is useful because it reduces the number of entries of the cache which have to be checked to determine whether the cache stores data associated with a specified target address, but in comparison to a direct-mapped cache (where data fora given address can only be allocated to a single entry 204 selected based on the address), the set-associative placement scheme improves performance as there is flexibility to allocate data for a given address to two or more locations, which reduces the likelihood of thrashing as it means two or more different addresses mapping to the same set can each be cached simultaneously.

FIG. 3 illustrates an entry of the cache in more detail. Each entry 204 may specify a cache tag value 302 and a data value 304. The data value 304 is the information of interest which is stored in the corresponding cache entry 204. The data value 304 could be data or instructions, address mapping information, or prediction metadata. The tag 302 corresponds to a portion of the target address which is not used to generate the index, and is stored alongside the cached data 304 to allow the different addresses which map to the same index to be distinguished from each other when looking up in the cache. Each entry 204 may also store state information associated with the corresponding address, such as a valid indicator 300 indicating whether the data in the corresponding entry 204 is valid, coherency state information (e.g. a dirty bit indicating whether the data value 304 has been modified compared to the corresponding data value in a higher level cache (e.g. L2 or L3 cache) or memory), or replacement policy information for selecting a victim cache entry when an entry needs to be evicted from the cache.

Hence, on a cache access to check whether data associated with a target address is stored in the cache, the index value 209 derived from the target address is used to select a set 208 and each of the tag values 302 in the entries 204 within the selected set 208 are compared with the tag portion of the target address. If any of the read tag values 302 match the tag portion of the target address then the corresponding cache entry 204 having the matching tag 302 stores the data for the requested target address, and that entry can be read or written depending on the type of access being performed. The scenario when one of the tags 302 in the indexed set 208 matches the tag of the target address is called a cache hit.

On the other hand, if none of the tags 302 in the indexed set 208 match the tag of the target address, then this is known as a cache miss, and in this case the information associated with the target address may need to be fetched from a further data store, such as a further level of cache or main memory. If one of the indexed set of caches is invalid, then the invalid entry can be selected for allocating the new data associated with a target address. However, if all of the indexed set of entries are already filled with valid data then one entry 204 of the indexed set 208 can be selected as a victim entry for which the data 304 is to be evicted from the cache to make way for the new information associated with the target address.

As shown in FIG. 3, the entries 204 may also provide a metadata flag 306 indicating whether the data 304 of that entry is prediction metadata associated with the prediction circuitry (e.g., prefetcher 40), when the metadata flag has a first value (e.g., 1) or is other information associated with another transaction source, such as instructions, data, or address translation information when the metadata flag has a second value (e.g., 0). It will be appreciated that the metadata flag may be a single bit or multi-bit value and the encodings representing the two values are not particularly limited. The metadata flag can be used to select entries for eviction to enforce the metadata partition size, and can also be used to determine the prediction metadata usefulness metric, as will be discussed in greater detail below.

The entries may also provide one or more flags 308 indicating whether the entry 204 was previously prefetched into the shared cache. The flags 308 may be set when the entry is fetched into the cache in response to a prefetch request, and cleared the first time the entry is accessed by a demand access. Multiple flags may be provided if there are several prefetch mechanisms which can be used to fetch entries into the cache, and which flags are set for a given entry 204 may depend on which prefetch mechanism was used to prefetch that entry into the cache. The prefetched flags 308 can be used to select instructions for training the prefetcher 40, as discussed below.

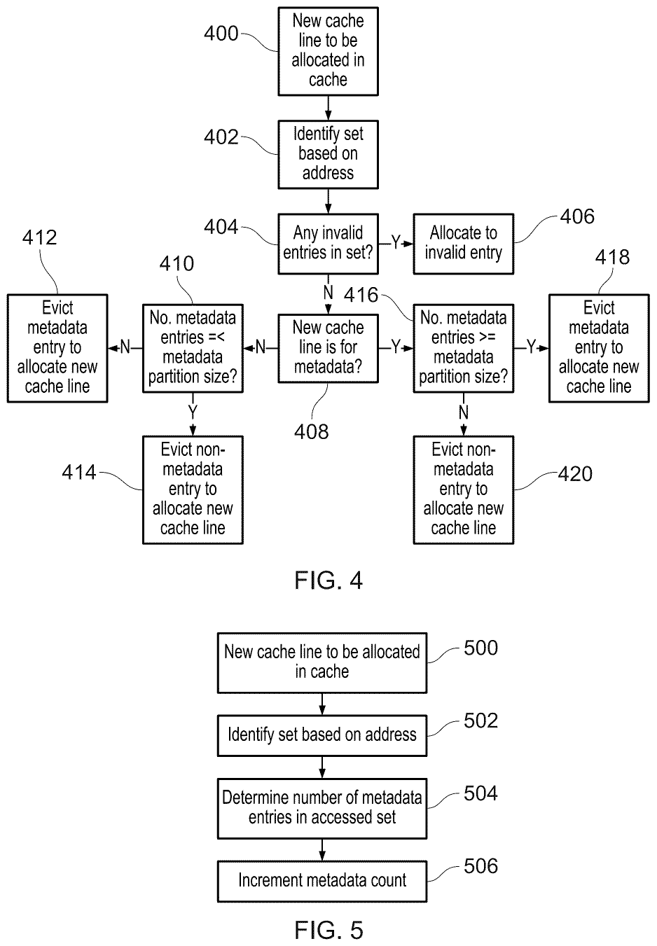

FIG. 4 is a flow diagram illustrating a method of allocating entries into the L2 cache in accordance with the metadata partition size. The method of FIG. 4 may be carried out by allocation and eviction circuitry provided by the L2 cache 12.

At step 400 it is determined that a new cache line is to be allocated into the cache. For example, the new entry may be an entry evicted from a higher level cache, data retrieved in response to a prefetch request, data retrieved from memory in response to a load or store instruction, prediction metadata generated by prediction circuitry, and so on.

At step 402 an index value 209 is computed based on an address associated with the cache line, and a set 208 is accessed based on the index 209. The set 208 includes the locations at which the cache line may be stored.

At step 404 it is determined whether any of the entries in the accessed set 208 are invalid. If so, then no entries need to be evicted to accommodate the new entry, and therefore at step 406 the new entry is allocated to one of the invalid entries. The metadata partition size may restrict allocation of entry to the cache when there is contention for entries, but when there are invalid entries in the cache there may be no need to enforce the metadata partition size, and accordingly the metadata partition size does not restrict allocation into invalid entries. This means that the number of metadata entries in each set may exceed the metadata partition size if there are available entries in the accessed set 208 at the time of allocation of the metadata entries. Similarly, the further data may occupy a larger number of entries than the difference between the set size and the metadata partition size when there were invalid entries in the cache at the time of allocation of the further data.

If at step 404 it is determined that there are no invalid entries in the set, then an entry needs to be evicted to accommodate the new entry. Which entry will be evicted can be selected based on the metadata partition size. For example if there are more metadata entries in the set than the metadata partition size then a metadata entry may be evicted (leaving the total number of metadata entries unchanged if the new cache line contains prediction metadata or bringing the number of metadata entries towards the metadata partition size if the new cache line contains further data) and if there are fewer metadata entries in the set than the metadata partition size then a non-metadata entry may be evicted (leaving the total number of metadata entries unchanged if the new cache line contains further data or bringing the number of metadata entries towards the metadata partition size if the new cache line contains prediction metadata).

Hence, at step 408 it is determined whether the new cache line contains prediction metadata. If the new entry is a non-metadata entry, then at step 410 it is determined whether the number of metadata entries in the accessed set is less than or equal to the metadata partition size. If so, a non-metadata entry is selected for eviction at step 414 (e.g., based on the eviction policy used for the cache) to create room for the new non-metadata entry (leaving the number of metadata entries in the cache unchanged). If the number of metadata entries in the accessed set is greater than the metadata partition size then a metadata entry is selected for eviction at step 412 to make room for the new non-metadata entry (reducing the number of metadata entries towards the metadata partition size).

If the new entry is at metadata entry, then at step 416 it is determined whether the number of metadata entries in the accessed set is greater than or equal to the metadata partition size. If so, a metadata entry is selected for eviction at step 418 (e.g., based on the eviction policy used for the cache) to create room for the new metadata entry (leaving the number of metadata entries in the cache unchanged). If the number of metadata entries in the accessed set is less than the metadata partition size then a non-metadata entry is selected for eviction at step 420 to make room for the new metadata entry (increasing the number of metadata entries towards the metadata partition size).

In any case, when a new entry 204 is allocated in the cache the metadata flag 306 is set to indicate whether the new cache line contains prediction metadata or not. The relevant prefetched flags 308 are also set if the new cache line was fetched in response to a prefetch request.

It will be appreciated that the approach illustrated in FIG. 4 is exemplary but not limiting, and the metadata partition size could be implemented in various ways. For example, a number of entries in each set could be reserved for exclusive use for prediction metadata (and the prediction metadata may not be stored in any other entries), imposing a hard partition for the prediction metadata. However, this may unnecessarily restrict use of the shared cache in cases where the number of required metadata entries is less than the metadata partition size or the number of required further entries is less than the difference between the set size and the metadata partition size. Imposing the metadata partition size based on a number of metadata entries in the set at cache allocation means that entries can be made available for metadata and non-metadata entries according to the metadata partition size, but that unused (invalid) entries can be used for either metadata or non-metadata as required.

It will also be appreciated that, while FIG. 4 illustrates a metadata partition size enforced on a per-set basis, alternative approaches could be used in which the metadata partition size is enforced based on the number of metadata entries in the whole cache. This might be more appropriate for a fully associative cache, for instance.

The metadata partition size may be selected by storage configuration circuitry 45, based on a prediction metadata usefulness metric. The prediction metadata usefulness metric may be determined based on a potential relative coverage indicating a potential performance improvement associated with the prediction circuitry, and a metadata occupancy representing how much of the shared cache is currently used for metadata.

FIG. 5 illustrates an approach for determining the metadata occupancy. At step 500, a new cache line is identified for allocation into the shared cache (e.g., this may be the same as step 400). Step 502 corresponds to step 402 and a set is identified based on an address of the new cache line.

At step 504, a number of metadata entries in the accessed set is determined. For example, adder circuitry could add together the values of the metadata flags 306 provided by the entries in the accessed set (e.g., when a value of 1 indicates a metadata entry and a value of 0 indicates a non-metadata entry).

At step 506, the number of metadata entries in the accessed set is used to update one or more metadata occupancy counters. The metadata occupancy counters may include a total number of observed metadata entries and a total number of entries in all of the accessed sets, to allow an average number of metadata entries per accessed set to be calculated. The average proportion of metadata entries in each accessed set could be used to calculate a metadata occupancy value, which may be expressed as the ratio between the observed metadata occupancy and a maximum metadata partition size.

The approach illustrated in FIG. 5 determines the metadata occupancy value based on the number of metadata entries in sets accessed during a particular workload. The number of metadata entries in sets which are not accessed does not contribute to the metadata occupancy value. The (biased) metadata occupancy value therefore more accurately represents how large the impact of metadata storage may be on performance for a particular workload, as it indicates how many entries are occupied by metadata (and therefore unavailable for other requesters) in the sets which might actually be used by a workload.

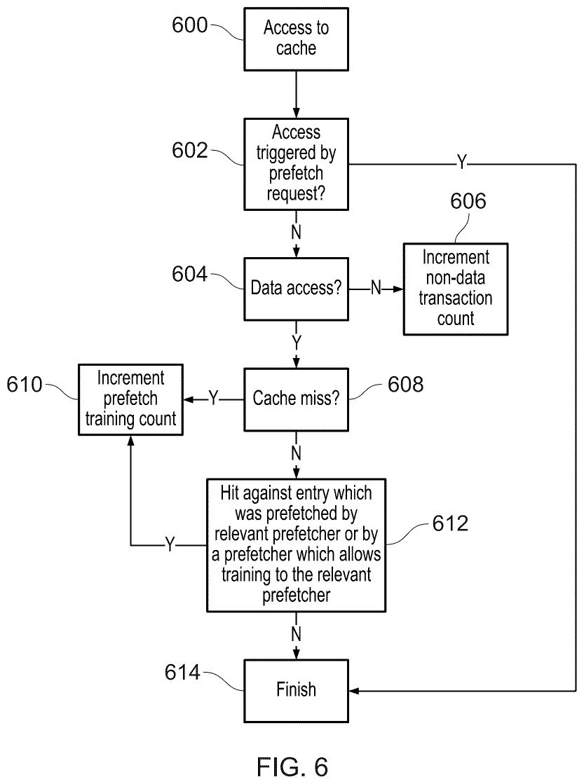

FIG. 6 illustrates an approach for determining values contributing to the potential relative coverage for the data prefetcher 40. At step 600, an access is made to a relevant cache for a particular prefetch mechanism for which the coverage is being assessed (e.g., the L2 cache 12). The counters include a non-data transaction counter, and a prefetcher training counter.

At step 602 it is determined whether the access was triggered by a prefetch request. If so, then neither counter is updated. This can avoid circular dependencies between accesses caused by the prefetcher and mechanisms to evaluate performance of the prefetcher.

If the access is not a prefetch, then at step 604 it is determined whether the access is a data access (e.g., in response to a load instruction or store instruction). It is noted that, if the coverage were instead being evaluated for a different type of prefetcher (e.g., an instruction prefetcher) then step 604 would check for the different type of access request.

If the access is not a data access, then at step 606 the non-data transaction counter is incremented.

If the access is a data access, then at step 608 it is determined whether the request hit in the cache or missed. If the request missed, then the request will be included in the input stream for training the prefetcher 40 and therefore the prefetcher training counter is incremented at step 610.

If the request hit, then at step 612 it is determined whether the request hit against a line which was prefetched into the cache by a relevant prefetch mechanism. The relevant prefetch mechanisms (for the data prefetcher 40) include the data prefetcher 40 itself and any other prefetch mechanism which allows training of the data prefetcher, such as any other mechanism which might fetch data which could have alternatively been fetched by the data prefetcher. By including such accesses in the training stream, the prefetcher 40 continues to be trained to fetch data which was only in the cache due to prefetching, and reduces the risk of missing prefetching that data in future. The evaluation at step 612 can be carried out by determining whether the relevant prefetched flag 308 (for the prefetcher 40) is set in the accessed entry of the cache.

If the access hit against a data entry which was either prefetched into the cache by a non-relevant prefetch mechanism or was fetched into the cache in response to a demand access, then the training count is not incremented and the process finished at step 614.

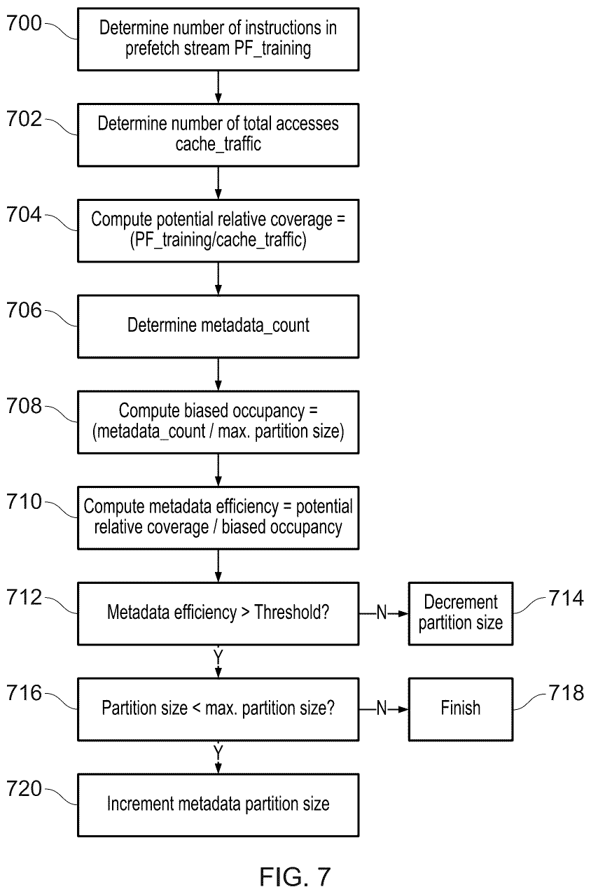

FIG. 7 illustrates an approach for using the prefetcher training counter, the non-data transaction counter, and the metadata occupancy for determining the metadata partition size.

Step 700 indicates the prefetcher training counter PF_training being determined, as illustrated in step 610 of FIG. 6. At step 702 a total activity of transactions to the relevant cache (the cache into which data may be prefetched by the prefetcher 40, for which performance is being assessed) can be calculated. The total activity, cache_traffic, can be calculated by adding together the input stream of the prefetcher and the non-data transactions determined at step 606 of FIG. 6, such that cache_traffic=P R_traffic+nonD_traffic. This calculation of total traffic excludes traffic caused by prefetches triggered by the prefetcher 40 to avoid circular dependencies.

At step 704 the potential relative coverage can be determined as the ratio of the number of accesses in the training stream (representing the accesses for which the prefetcher 40 might provide a prediction) compared to the total cache traffic, therefore representing a proportion of total cache activity which might be predicted using the prefetcher 40.

At step 706 the metadata_count is determined as described with respect to FIG. 5, and at step 708 a biased occupancy value is determined as the ratio between the average metadata occupancy in the observed sets and the maximum metadata partition size.

At step 710 the metadata efficiency (an example of the prediction metadata usefulness metric) can be computed as the ratio between the potential relative coverage (what proportion of cache traffic could be predicted by the prefetcher) and the biased metadata occupancy (how much prediction metadata is being generated). The metadata efficiency can be used to select the metadata partition size, as it may represent what is the potential gain in terms of coverage with respect to the fraction of the cache storing metadata.

Various approaches may trigger the evaluations of steps 704 to 710 in different ways. In one example, the metadata efficiency may be calculated (and the metadata partition size updated) in response to cache_traffic reaching a threshold value, but it will be appreciated that other approaches may be used, such as updating the metadata partition size at regular time intervals.

Once the metadata efficiency has been calculated, it can be compared to a threshold at step 712 to determine whether to increase or decrease the metadata partition size.

If the metadata efficiency is high then the potential performance improvements might be significant compared to the amount of storage required for prediction metadata and therefore the partition size may be increased, and vice versa.

Hence, if the metadata efficiency is lower than the threshold then at step 714 the metadata partition size may be reduced (ensuring that it is not reduced below a minimum partition size, which in some cases may be greater than zero).

If the metadata efficiency is higher than the threshold then at step 720 the metadata partition size is increased, as long as the partition size is determined to be below a maximum partition size at step 716 (otherwise the metadata partition size is left at the maximum partition size at step 718).

It will be appreciated that the increment/decrement size is not particularly limited, and could for example be one.

In one example, the threshold value is one. As metadata_efficiency=potential relative coverage/biased metadata occupancy, then determining if metadata_efficiency=potential relative coverage/biased metadata occupancy >1 is the same as determining if potential relative coverage>biased metadata occupancy. The use of a threshold of one can therefore permit a particularly simple implementation of the comparison.

It will be appreciated that the steps of FIG. 7 may be carried out in a different order, and in practice several steps may be carried out in parallel. For example, the biased metadata occupancy count may be determined in parallel with the potential relative coverage.

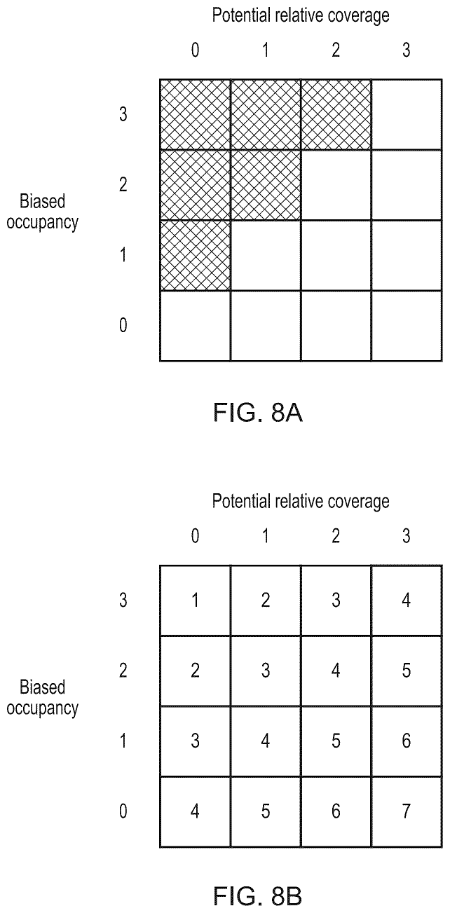

FIGS. 8A and 8B schematically illustrate an alternative approach for updating the metadata partition size based on the potential relative coverage and biased metadata occupancy (elements of the metadata prediction usefulness metric) determined at steps 704 and 708 of FIG. 7.

FIGS. 8A and 8B each illustrate a two-dimensional matrix approach. The potential relative coverage and the biased occupancy may each be associated with a score between 0 and 3. The table illustrated below indicates one approach for associating a percentage value with a score, where a flag may be set or not set depending on whether the value meets a criterion—e.g., the first row is all zeros indicating that a value which is below 10%, below 50%, and below 90% has no flags set and the score is calculated as a sum of the flags as zero. Similarly, the third row indicates that a value which is above 10%, above 50%, but below 90% has a score of 2.

The potential relative coverage and the biased occupancy are both expressed as ratios and therefore can be assessed using the same approach shown in the table. If the potential relative coverage is higher then it gets a higher score, e.g., if the potential relative coverage indicates that over 90% of the total traffic can be predicted by the prefetcher 40 then it may get a score of 3. If the biased occupancy is higher then it gets a higher score, e.g., if the biased occupancy indicates that over 90% of the maximum metadata partition size is occupied with prediction metadata then the score is 3.

| >10%? | >50%? | >90%? | Score |
|---|---|---|---|
| 0 | 0 | 0 | 0 |
| 1 | 0 | 0 | 1 |
| 1 | 1 | 0 | 2 |
| 1 | 1 | 1 | 3 |

The scores calculated in this manner are used to access an element of a matrix.

FIG. 8A illustrates an approach wherein the accessed entry of the matrix indicates whether the metadata partition size should be increased or decreased. For example, if the relative potential coverage is 3 (high) and the metadata occupancy is 0 (low) then the metadata partition size may be increased. It will be seen that a higher potential relative coverage, and a lower metadata occupancy are more likely to cause the metadata partition size to be increased. It will be appreciated that the approach shown in FIG. 8A may be similar to the use of a threshold. However, the matrix approach can allow more flexibility in adjusting the metadata partition size. For example, the matrix may indicate that whenever the biased occupancy is 3 then the metadata partition size should be reduced regardless of the potential relative coverage, and so on.

FIG. 8B illustrates a further approach of a matrix which may be accessed in a similar way to the matrix of FIG. 8A, but which may indicate the new metadata partition size rather than merely indicating whether the metadata partition size should be increased or decreased. The example of FIG. 8 is given for an 8-way set associative cache, and provides metadata partition sizes between 1 and 7. Similar to FIG. 8A, larger metadata partitions may be used when the potential relative coverage is higher, and larger metadata partitions may be used when the biased occupancy is lower.

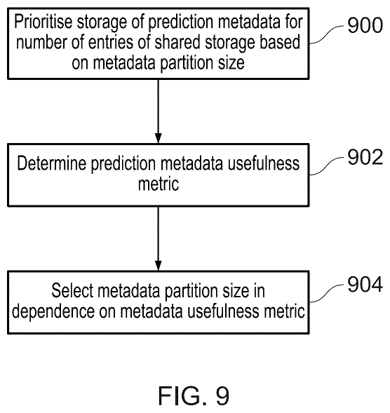

FIG. 9 is a flow diagram illustrating a method for controlling shared storage circuitry storing prediction metadata. At step 900 the shared storage circuitry prioritises storage of prediction metadata for a number of entries of the shared storage circuitry selected based on a metadata partition size.

At step 902 storage configuration circuitry 45 determined a prediction metadata usefulness metric, and at step 904 the storage configuration circuitry selects the metadata partition size based on the prediction metadata usefulness metric.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

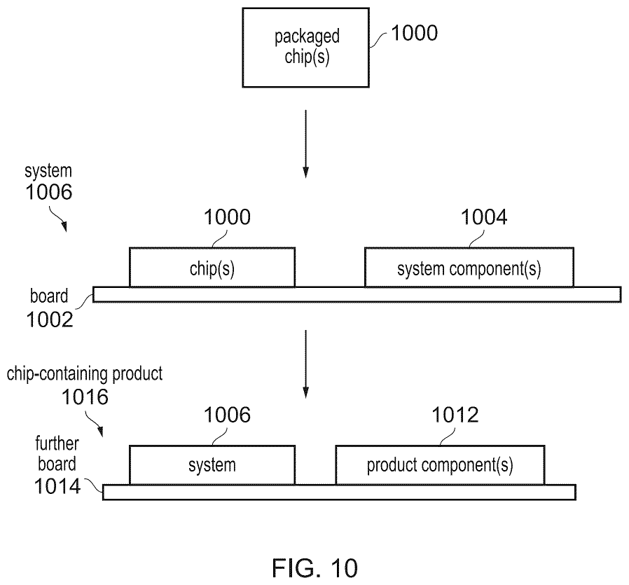

As shown in FIG. 10, one or more packaged chips 1000, with the apparatus described above implemented on one chip or distributed over two or more of the chips, are manufactured by a semiconductor chip manufacturer. In some examples, the chip product 1000 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. W here more than one chip 1000 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 1000 are assembled on a board 1002 together with at least one system component 1004 to provide a system 1006. For example, the board may comprise a printed circuit board. The board substrate may be made of any of a variety of materials, e.g. plastic, glass, ceramic, or a flexible substrate material such as paper, plastic or textile material. The at least one system component 1004 comprise one or more external components which are not part of the one or more packaged chip(s) 1000. For example, the at least one system component 1004 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 1016 is manufactured comprising the system 1006 (including the board 1002, the one or more chips 1000 and the at least one system component 1004) and one or more product components 1012. The product components 1012 comprise one or more further components which are not part of the system 1006. As a non-exhaustive list of examples, the one or more product components 1012 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 1006 and one or more product components 1012 may be assembled on to a further board 1014.

The board 1002 or the further board 1014 may be provided on or within a device housing or other structural support (e.g. a frame or blade) to provide a product which can be handled by a user and/or is intended for operational use by a person or company.

The system 1006 or the chip-containing product 1016 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (F PGA) to configure the FPGA to embody the described concepts. The FPGA may be deployed for the purposes of verification and test of the concepts prior to fabrication in an integrated circuit or the F PGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:
1. An apparatus, comprising:
   prediction circuitry configured to provide data processing predictions to control speculation of data processing operations by data processing circuitry;
   shared storage circuitry comprising a plurality of entries each configured to store one of: prediction metadata associated with the prediction circuitry, and further data associated with at least one further transaction source,
   wherein the shared storage circuitry is configured to prioritise storage of the prediction metadata over storage of the further data for a number of entries of the shared storage circuitry selected in dependence on a metadata partition size; and
   storage configuration circuitry configured to dynamically select the metadata partition size in dependence on a prediction metadata usefulness metric.
2. The apparatus according to clause 1, wherein the shared storage circuitry comprises a shared cache within a memory system accessed by the data processing circuitry.
3. The apparatus according to any preceding clause, wherein the storage configuration circuitry is configured to select the metadata partition size to be greater than zero.
4. The apparatus according to any preceding clause, wherein the storage configuration circuitry is configured to select the metadata partition size to be lower than a total number of entries of the shared cache.
5. The apparatus according to any preceding clause, wherein the shared storage circuitry has a set-associative structure, and the metadata partition size indicates a number of entries per set for which the shared storage circuitry is configured to prioritise storage of the prediction metadata over storage of the further data.
6. The apparatus according to any preceding clause, wherein the storage configuration circuitry is configured to determine the prediction metadata usefulness metric based on a potential coverage estimate of the prediction circuitry.
7. The apparatus according to clause 6, wherein the potential coverage estimate is based on a proportion of data processing operations for which the prediction circuitry is estimated to be capable of providing a data processing prediction.
8. The apparatus according to any of clauses 6 and 7, wherein the prediction circuitry comprises prefetch circuitry for prefetching into a cache, and the potential coverage estimate is based on a number of access requests forming part of an input stream to the prefetch circuitry.
9. The apparatus according to clause 8, wherein an access request forms part of the input stream when the access request is of a relevant type and either: misses in the cache, or hits against an entry previously prefetched into the cache by a relevant prefetch mechanism.
10. The apparatus according to any of clauses 8 and 9, wherein the potential coverage estimate is based on a total number of relevant accesses to the cache.
11. The apparatus according to any preceding clause, wherein the storage configuration circuitry is configured to determine the prediction metadata usefulness metric based on a metadata occupancy value representing a number of entries in the shared storage circuitry identified as storing prediction metadata.
12. The apparatus according to clause 11, wherein the shared storage circuitry has a set-associative structure, and the storage configuration circuitry is configured to determine the metadata occupancy value based on a number of entries storing prediction metadata in one or more accessed sets of the shared storage circuitry.
13. The apparatus according to any preceding clause, wherein the storage configuration circuitry is configured to increment or decrement the metadata partition size in dependence on the prediction metadata usefulness metric.
14. The apparatus according to any of clauses 1 to 12, wherein the storage configuration circuitry is configured to select a precomputed metadata partition size in dependence on the prediction metadata usefulness metric.
15. The apparatus according to any preceding clause, wherein when allocating a new entry in an accessed region of the shared storage circuitry:
   the shared storage circuitry is responsive to a number of entries of in the accessed region storing the prediction metadata being greater than the metadata partition size to favour eviction of an entry storing the prediction metadata over an entry storing the further data, and
   the shared storage circuitry is responsive to a number of entries of in the accessed region storing prediction metadata being less than the metadata partition size to favour eviction of an entry storing the further data over an entry storing the prediction metadata.
16. The apparatus according to any preceding clause, wherein the prediction circuitry comprises prefetch circuitry, and the prediction metadata comprises information representing relations which enable later memory accesses to be predicted based on earlier memory accesses.
17. A system comprising:
   the apparatus of any preceding clause, implemented in at least one packaged chip;
   at least one system component; and
   a board,
   wherein the at least one packaged chip and the at least one system component are assembled on the board.
18. A chip-containing product comprising the system of clause 17, wherein the system is assembled on a further board with at least one other product component.
19. A method, comprising:
   providing data processing predictions to control speculation of data processing operations by data processing circuitry;
   storing any one of: prediction metadata and further data associated with at least one further transaction source in a plurality of entries of shared storage circuitry;
   prioritising storage of the prediction metadata over storage of the further data for a number of entries of the shared storage circuitry selected in dependence on a metadata partition size; and
   dynamically selecting the metadata partition size in dependence on a prediction metadata usefulness metric.
20. Computer-readable code for fabrication of an apparatus, comprising:
   prediction circuitry configured to provide data processing predictions to control speculation of data processing operations by data processing circuitry;
   shared storage circuitry comprising a plurality of entries each configured to store one of: prediction metadata associated with the prediction circuitry, and further data associated with at least one further transaction source,
   wherein the shared storage circuitry is configured to prioritise storage of the prediction metadata over storage of the further data for a number of entries of the shared storage circuitry selected in dependence on a metadata partition size; and
   storage configuration circuitry configured to dynamically select the metadata partition size in dependence on a prediction metadata usefulness metric.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
prediction circuitry configured to provide data processing predictions to control speculation of data processing operations by data processing circuitry;
shared storage circuitry comprising a plurality of entries each configured to store one of: prediction metadata associated with the prediction circuitry or further data associated with at least one further transaction source,
wherein the shared storage circuitry is configured to prioritise storage of the prediction metadata at a higher priority than storage of the further data for a number of entries of the shared storage circuitry, wherein the number of entries is selected in dependence on a metadata partition size; and
storage configuration circuitry configured to dynamically select the metadata partition size in dependence on a prediction metadata usefulness metric.

2. The apparatus according to claim 1, wherein the shared storage circuitry comprises a shared cache within a memory system accessed by the data processing circuitry.

3. The apparatus according to claim 1, wherein the storage configuration circuitry is configured to select the metadata partition size to be greater than zero.

4. The apparatus according to claim 1, wherein the storage configuration circuitry is configured to select the metadata partition size to be lower than a total number of entries of the shared cache.

5. The apparatus according to claim 1, wherein the shared storage circuitry has a set-associative structure, and the metadata partition size indicates a number of entries per set for which the shared storage circuitry is configured to prioritise storage of the prediction metadata over storage of the further data.

6. The apparatus according to claim 1, wherein the storage configuration circuitry is configured to determine the prediction metadata usefulness metric based on a potential coverage estimate of the prediction circuitry.

7. The apparatus according to claim 6, wherein the potential coverage estimate is based on a proportion of data processing operations for which the prediction circuitry is estimated to be capable of providing a data processing prediction.

8. The apparatus according to claim 6, wherein the prediction circuitry comprises prefetch circuitry for prefetching into a cache, and the potential coverage estimate is based on a number of access requests forming part of an input stream to the prefetch circuitry.

9. The apparatus according to claim 8, wherein an access request forms part of the input stream when the access request is of a relevant type and either: misses in the cache, or hits against an entry previously prefetched into the cache by a relevant prefetch mechanism.

10. The apparatus according to claim 8, wherein the potential coverage estimate is based on a total number of relevant accesses to the cache.

11. The apparatus according to claim 1, wherein the storage configuration circuitry is configured to determine the prediction metadata usefulness metric based on a metadata occupancy value representing a number of entries in the shared storage circuitry identified as storing prediction metadata.

12. The apparatus according to claim 11, wherein the shared storage circuitry has a set-associative structure, and the storage configuration circuitry is configured to determine the metadata occupancy value based on a number of entries storing prediction metadata in one or more accessed sets of the shared storage circuitry.

13. The apparatus according to claim 1, wherein the storage configuration circuitry is configured to increment or decrement the metadata partition size in dependence on the prediction metadata usefulness metric.

14. The apparatus according to claim 1, wherein the storage configuration circuitry is configured to select a precomputed metadata partition size in dependence on the prediction metadata usefulness metric.

15. The apparatus according to claim 1, wherein when allocating a new entry in an accessed region of the shared storage circuitry:
the shared storage circuitry is responsive to a number of entries storing the prediction metadata in the accessed region being greater than the metadata partition size to favour eviction of an entry storing the prediction metadata over an entry storing the further data, and
the shared storage circuitry is responsive to a number of entries storing prediction metadata in the accessed region being less than the metadata partition size to favour eviction of an entry storing the further data over an entry storing the prediction metadata.

16. The apparatus according to claim 1, wherein the prediction circuitry comprises prefetch circuitry, and the prediction metadata comprises information representing relations which enable later memory accesses to be predicted based on earlier memory accesses.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method, comprising:
providing data processing predictions to control speculation of data processing operations by data processing circuitry;
storing any one of: prediction metadata or further data associated with at least one further transaction source in a plurality of entries of shared storage circuitry;
prioritising storage of the prediction metadata at a higher priority than storage of the further data for a number of entries of the shared storage circuitry, wherein the number of entries is selected in dependence on a metadata partition size; and
dynamically selecting the metadata partition size in dependence on a prediction metadata usefulness metric.

20. A non-transitory computer-readable medium storing computer-readable code for fabrication of an apparatus, comprising:
prediction circuitry configured to provide data processing predictions to control speculation of data processing operations by data processing circuitry;
shared storage circuitry comprising a plurality of entries each configured to store one of: prediction metadata associated with the prediction circuitry or further data associated with at least one further transaction source,
wherein the shared storage circuitry is configured to prioritise storage of the prediction metadata at a higher priority than storage of the further data for a number of entries of the shared storage circuitry, wherein the number of entries is selected in dependence on a metadata partition size; and
storage configuration circuitry configured to dynamically select the metadata partition size in dependence on a prediction metadata usefulness metric.
